(19) United States
(12) Patent Application Publication
(10) Pub. No.: US 2023/0408295 A1
(43) Pub. Date: Dec. 21, 2023

(54) METHOD FOR SETTING THRESHOLD VALUE OF SENSOR

(71) Applicant: MOVIC LAB INC., Incheon (KR)

(72) Inventor: Won Keun LEE, Incheon (KR)

(21) Appl. No.: 18/250,097

(22) PCT Filed: Oct. 20, 2021
(86) PCT No.: PCT/KR2021/014759

§ 371 Date: Apr. 21, 2023

(30) Foreign Application Priority Data
Oct. 22, 2020 (KR) 10-2020-0137804

(51) Int. Cl. G01D 3/032; G01D 3/024

(52) U.S. Cl. CPC G01D 3/032; G01D 3/024

(57) ABSTRACT

A method for setting a threshold value of a sensor is provided. Provided is a method in which a sensor system, including at least one processor and at least one port for transferring a signal to the at least one processor, sets the threshold value of a sensor, the method comprising: an initial reception step in which the at least one processor receives an input value of the sensor, connected to the port, through the port during a first time; an identification step in which the at least one processor identifies the type of sensor on the basis of to which section the input value received in the initial reception step corresponds from among a plurality of predetermined sections; a first type threshold value setting step in which, when the sensor is identified as a first type in the identification step, the at least one processor sets a predetermined threshold value as the threshold value of the port according to the type of the sensor; and a second type threshold value setting step in which, when the sensor is identified as a second type in the identification step, the at least one processor receives an input value of the sensor, connected to the port, through the port during a second time, so as to calculate an average input value during the second time, and sets the threshold value of the port on the basis of the average input value.

### TECHNICAL FIELD

The present disclosure relates to a method for setting a threshold value of a sensor, and more particularly, a method of identifying a type of a sensor among various types of sensors that sense temperature, humidity, etc. based on an input value provided by the sensor, and setting a threshold value of the sensor according to the type of the sensor.

### BACKGROUND ART

In general, many sensors are used to measure various environmental changes, for example, detecting a malfunction at an industrial site or monitoring a fire. Since there are so many types of sensors and many commercial products are on the market, it is possible to detect malfunctions or fires from a comprehensive perspective by integrating the sensors. However, an interface capable of accommodating various types of sensors is required to perform integrated control of these various sensors.

In addition, since it is important to determine whether or not a set threshold value is exceeded in order to detect an abnormality such as a malfunction or fire, there is a problem in that different threshold values must be assigned to the respective sensors.

In addition, since the sensors are installed in various environments, the normal temperature, humidity, etc. may vary depending on an installation location, so there is a problem that it is necessary to set a threshold suitable for an environment in which a sensor is installed.

Therefore, a method for accommodating various types of sensors in a general industrial field and setting appropriate threshold values according to the types of sensors.

### Related Document

Korean Patent Application Publication No. 2020-0072728 (Publication Date: Jun. 23, 2020, Title of Invention: FIRE DETECTION SENSOR DEVICE AND SYSTEM)

### DISCLOSURE

### Technical Problem

An objective of the present disclosure is to provide a method for accommodating various types of sensors and setting the types of sensors and threshold values based on output values of the sensors.

### Technical Solution

A method for setting a threshold value of a sensor of the present disclosure for solving the aforementioned problem is a method for setting a threshold value of a sensor in a sensor system having at least one processor and at least one port for transmitting a signal to the at least one processor, the method including: an initial reception step in which the at least one processor receives an input value of a sensor, connected to the port, through the port during a first period of time; an identification step in which the at least one processor identifies a type of the sensor based on to which section the input value received in the initial reception step corresponds among a plurality of predetermined sections; a first classification threshold setting step in which, in response to the sensor being identified as a first classification in the identification step, setting, the at least one processor sets a predetermined threshold value as a threshold value of the port according to the type of the sensor; and a second classification threshold value setting step in which, in response to the sensor being identified as a second classification in the identification step, receiving, the at least one processor calculates an input value of the sensor, connected to the port, through the port during a second period of time to calculate an average input value during the second period of time and sets a threshold value of the port based on the average input value.

The method for setting a threshold value of a sensor according to an embodiment of the present disclosure may be a method for setting a threshold value of a sensor, the method in which the initial reception step further includes removing noise from the input value of the sensor.

The method for setting a threshold value of a sensor according to an embodiment of the present disclosure may be a method for setting a threshold value of a sensor, the method in which the second period of time is longer than the first period of time.

The method for setting a threshold value of a sensor according to an embodiment of the present disclosure may be a method for setting a threshold value of a sensor, the method in which the first classification is a classification for sensing temperature or humidity and the second classification is a classification for sensing infrared rays or carbon dioxide concentration.

The method for setting a threshold value of a sensor according to an embodiment of the present disclosure may be a method for setting a threshold value of a sensor, the method in which the sensor system is a fire detection system.

The method for setting a threshold value of a sensor according to an embodiment of the present disclosure may be a method for setting a threshold value of a sensor, the method in which the sensor system further includes a memory, the memory stores the threshold value according to a type of the sensor of the first classification, and the first classification threshold value includes loading the threshold from the memory by the at least one processor.

The method for setting a threshold value of a sensor according to an embodiment of the present disclosure may be a method for setting a threshold value of a sensor, the method in which the sensor system further includes a memory, the memory stores the multiple value according to a type of the sensor of the second classification, and the second classification threshold setting step includes loading the multiple value from the memory by the at least one processor.

The method for setting a threshold value of a sensor according to an embodiment of the present disclosure may be a method for setting a threshold value of a sensor, the method in which the first classification threshold value setting step further includes setting a range of input values for each type of the sensor and identifying a type of the sensor according to an input value received during the first period of time.

The method for setting a threshold value of a sensor according to an embodiment of the present disclosure may be a method for setting a threshold value of a sensor, the method in which the second classification threshold value setting step further includes setting a range of input values for each type of the sensor and identifying the type of the sensor according to an input value received during the first period of time.

The method for setting a threshold value of a sensor according to an embodiment of the present disclosure may be a method for setting a threshold value of a sensor, the method in which, in the second classification threshold setting step, the at least one processor sets, as the threshold value of the port, a product obtained by multiplying the average input value by a predetermined multiple value according to the type of the sensor.

In addition, a sensor system of the present disclosure for solving the aforementioned problem is a sensor system including: a memory; at least one processor configured to execute instructions stored in the memory; and at least one port configured to transmit a signal to the at least one processor, and the processor is further configured to: receive an input value of a sensor, connected to the port, through the port during a first period of time, and identify a classification for the sensor based on to which section the input value received in the initial reception step corresponds from among a plurality of predetermined sections, and, in response to the sensor being identified as a first classification in the identification step, the at least one processor sets a predetermined threshold value according to the type of the sensor as a threshold value of the port, and in response to the sensor being identified as the second classification in the identifying step, the at least one processor receives an input value of a sensor, connected to the port, through the port during a second period of time, and calculates an average input value during the second period of time.

### Advantageous Effects

According to an embodiment of the present disclosure, it is possible to accommodate various types of sensors, and to identify an arbitrary sensor and set a threshold value of the arbitrary sensor according to a type of the arbitrary sensor.

### DESCRIPTION OF DRAWINGS

FIG. 1 is a configuration diagram of a sensor system according to an embodiment of the present disclosure.

FIG. 2 is a flowchart of a method for setting a threshold value of a sensor according to an embodiment of the present disclosure.

FIG. 3 is a diagram illustrating an example in which a processor sets a range for an input value to distinguish a classification and type of a sensor according to an embodiment of the present disclosure.

FIG. 4 is a diagram illustrating that a processor according to an embodiment of the present disclosure calculates an average input value during a second period of time.

FIG. 5 is a diagram illustrating an example in which a processor receives an input value exceeding a threshold value after a lapse of a first period of time and a second period of time according to an embodiment of the present disclosure;

### MODE FOR DISCLOSURE

Hereinafter, embodiments of the present disclosure will be described in detail with reference to the accompanying drawings. In describing the present disclosure, if it is determined that a detailed description of known functions and components associated with the present disclosure unnecessarily obscure the gist of the present disclosure, the detailed description thereof will be omitted. In addition, the terms used in this specification are used to appropriately express the embodiments of the present disclosure and may be altered according to a person of a related field or conventional practice. Therefore, the terms should be defined on the basis of the entire content of this specification.

The technical terms used herein are only for describing a special exemplary embodiment, but it is considered that the present disclosure is not limited thereto. As used herein, the singular forms include plural forms as long as the phrases do not clearly have a contrary sense. The meaning of “including” used in the specification specifies a specific characteristic, area, integer, step, action, element, and/or component, but it is not considered to eliminate the existence or addition of other characteristics, areas, integers, steps, actions, elements, and/or components.

In this specification, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

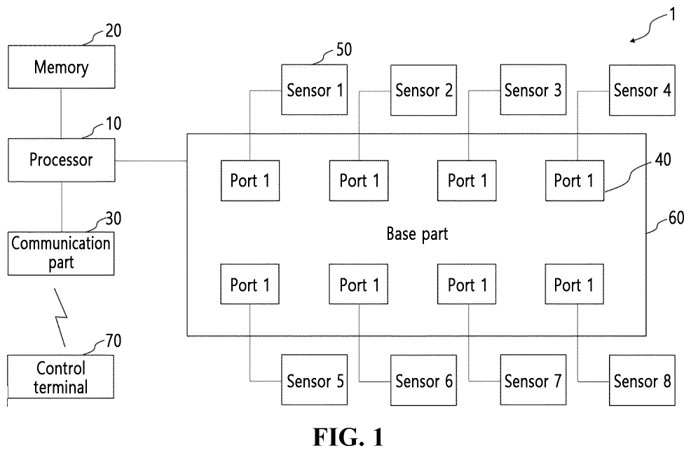

Hereinafter, a method for setting a threshold value of a sensor 50 according to an embodiment of the present disclosure will be described with reference to FIGS. 1 to 5.

The present disclosure relates to a method and system for setting a threshold value of a sensor 50 with respect to various types of the sensors 50.

The method for setting a threshold value of the sensor 50 with respect to various types of the sensors 50 of the present disclosure is performed by the sensor system 1.

FIG. 1 is a configuration diagram of the sensor system 1 according to an embodiment of the present disclosure.

Referring to FIG. 1, the sensor system 1 includes a memory 20, a processor 10, a communication part 30, at least one port 40, a base part 60, and at least one sensor 50. The sensor system 1 may communicate with a control terminal 70 via a network.

The function of each component will be described below.

The memory 20 store instructions executed by the processor 10, and in particular, may store a threshold value or multiple value applicable according to a type of the sensor 50. The processor 10 executes the instructions stored in the memory 20, identifies the type of the sensor 50 based on an input value of the sensor 50, which is received through the port 40, and sets a threshold value for each sensor 50. The port 40 receives the input value from the sensor 50 and transmits a signal to the processor 10. The sensor 50 may quantify and detect an external environmental factor. That is, temperature, humidity, infrared rays, carbon dioxide concentration, etc. may be sensed and digitized, and transmitted to the port 40.

A more specific function of each component will be hereinafter described in detail while explaining how to set a threshold value of the sensor 50.

The control terminal 70 described in this specification may include a mobile phone, a smart phone, a laptop computer, a digital broadcasting terminal, a personal digital assistant (PDA), a portable multimedia player (PMP), a navigation device, a slate PC, a tablet PC (tablet PC), an ultrabook (ultrabook), a wearable device (for example, a watch-type terminal (smartwatch), a glass-type terminal (smart glass), a head mounted display (HMD), etc.), and the like.

The control terminal 70 may include a communication module, and transmit and receive a radio signal with at least one of a base station, an external terminal, and a server on a mobile communication network established according to technical standards or communication methods for mobile communication (e.g., Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), etc.)

Hereinafter, each step of a method for setting a threshold value of the sensor 50 according to an embodiment of the present disclosure will be described.

The sensor 50 described in this specification may detect temperature, humidity, infrared rays, carbon dioxide concentration, etc., and may be, but not limited thereto, any sensor capable of detecting an external environment. However, in the following description, for convenience of explanation, it is assumed that the sensor 50 detects temperature, humidity, infrared rays, and carbon dioxide concentration.

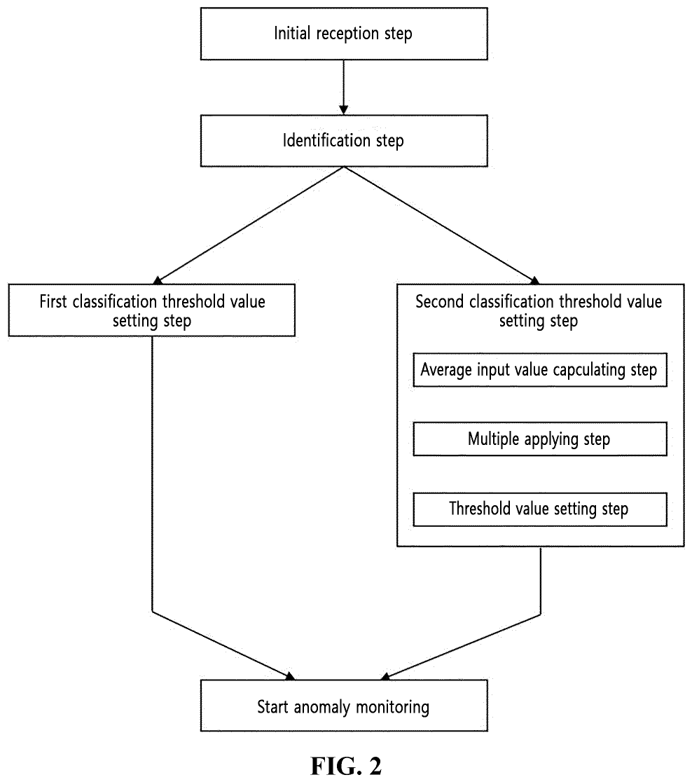

FIG. 2 is a flowchart of a method for setting a threshold value of the sensor 50 according to an embodiment of the present disclosure.

Referring to FIG. 2, the method includes: an initial reception step in which at least one processor 10 receives an input value of the sensor 50, connected to the port 40, through the port 40 during a first period of time; an identification step in which at least one processor 10 identifies a classification for the sensor 50 based on to which section an input value received in the initial reception step corresponds from among a plurality of predetermined sections; a first classification threshold setting step in which, in response to the sensor 50 being identified as a first classification in the identification step, at least one processor 10 sets a predetermined threshold according to a type of the sensor 50 as a threshold of the port 40; and a second classification threshold value setting step in which, in response to the sensor 50 being identified as a second classification in the identification step, at least one processor 10 receives an input value of the sensor 50, connected to the port 40, through the port 40 during a second period of time to calculate an average input value during the second period of time and sets a product obtained by multiplying an average input value by a predetermined multiple value according to the type of sensor 50 as a threshold value of the port 40.

Each of the steps described above may be performed irrespective of the listed order, except when performed in the listed order due to a special causal relationship. However, in the following description, it is assumed that the above-described steps are performed in the listed order for convenience of explanation.

First, with reference to FIG. 2, the initial reception step in which the processor 10 receives an input value of the sensor 50, connected to the port 40, through the port 40 during the first period of time will be described. As described above, the sensor 50 is connected to the port 40 and transmits a value obtained by measuring a sensing target such as temperature and humidity to the port 40 as an input value. The port 40 receives an input value and transmits the input value to the processor 10. Here, the input value may vary depending on the type of the sensor 50, and may be of an analog method or digital method. For example, in the case of the analog method, the input value of the specific sensor 50 may be input within a range of 0V to 5.0V. The input value may be a value measured by the sensor 50, or may be a value measured by the sensor 50 and then converted at a predetermined ratio.

The processor 10 receives an input value during the first period of time. Here, a time at which the first period of time starts may be regarded as a time when the sensor 50 is connected to the port 40 or a time when power is applied to the sensor system 1. That is, when a user connects the sensor 50 to the port 40, the processor 10 receives an input value from the port 40 during the first period of time thereafter. The first period of time is a period of time for receiving an input value to be used as basic data for identifying the classification for the sensor 50 in the subsequent identification step.

Having received the input value from the port 40, the processor 10 may remove unnecessary noise from the corresponding input value. Noise that can affect the input value may be added by a wire connecting between the port 40 and the processor 10 or between the port 40 and the processor 10. For example, an input value of a specific sensor 50 may be input in the range of 0V to 5.0V, but if an input value exceeding the range of 0V to 5.0V is received at a predetermined time, the input value is considered to have noise added. Therefore, the processor 10 removes the noise from the input value so that subsequent steps can proceed normally.

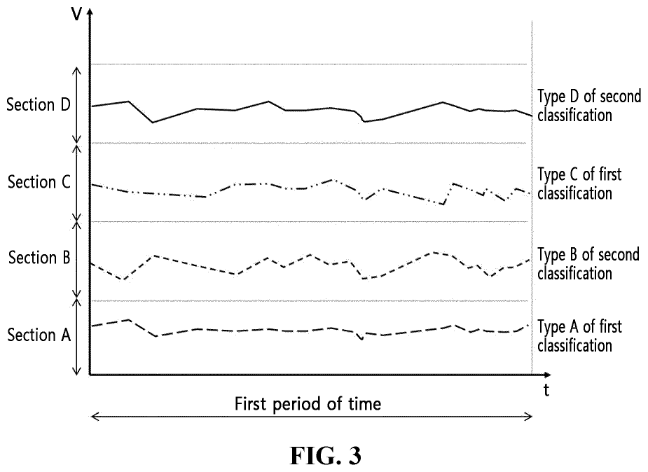

Next, referring to FIG. 3, the identification step in which the processor 10 identifies the classification for the sensor 50 based on to which section the input value received in the initial reception step corresponds from among a plurality of predetermined sections will be described. As shown in FIG. 3, the processor 10 may divide and distinguish an available range of input values into predetermined sections. Based on the distinguished section, it is possible to identify the classification and type of the sensor 50 according to the input value. For example, when an input value belonging to section B is received during the first period of time, the processor 10 may identify that the corresponding port 40 is connected to the sensor 50 of a second classification.

In this specification, a classification for sensor refers to a set of sensors for which a threshold value is set in a specific predetermined method. Specifically, a threshold value of a first classification sensor is set by a predetermined method in the first classification threshold setting step which will be described below. In addition, a threshold value of a second classification sensor is set by a predetermined method in the first classification threshold value which will be described below.

In addition, a type of sensor is specifically distinguished according to a target to be measured by the corresponding sensor. Specifically, if a sensor measures temperature, the type of the sensor is defined as a temperature type, and if another sensor measures infrared rays, the type of the sensor is defined as an infrared type.

Next, described is the first classification threshold value setting step in which in response to the sensor 50 being identified as the first classification in the above identification step, the processor 10 sets a predetermined threshold value according to the type of the sensor 50 as a threshold value of the port 40. Here, the first classification may be a classification for sensing temperature or humidity. As for a sensing target such as temperature or humidity, a threshold value may be set based on an input value received during a first period of time when the sensor system 1 is installed, regardlessly of a corresponding installation environment. At this point, the memory 20 stores the threshold value according to the first classification in advance, and the processor 10 may load the corresponding threshold value from the memory 20 to set a threshold value of the corresponding port 40.

In the first classification threshold value setting step, a range of input values may be set for each type of the sensor 50 and a type of the sensor 50 may be identified according to an input value received during the first period of time. For example, if the input value received by the sensor 50 is in a range of 0V to 5.0V, a range of 0V to 0.8V may be set as section A, a range of 0.8V to 1.6V may be set as section B, and a range of 1.6V to 2.4V may be set as section C, and a range of 2.4V-3.2V may be set as section D. Referring to FIG. 3, when an input value corresponding to section C is received during the first period of time, the processor 10 may identify that the sensor 50 is of the first classification and corresponds to type C, and accordingly, the memory 20 may load a threshold value corresponding to type C. If type C refers to a temperature sensor 50, the threshold value may be a predetermined voltage level corresponding to 50 degrees Celsius.

The first classification threshold value stored in the memory 20 may be changed by a user through the control terminal 70. Since the user needs to change the threshold value for the first classification as needed, the threshold value for the first classification stored in the memory 20 may be changed through the communication part 30 connected to the control terminal 70.

Next, described is the second classification threshold value setting step in which, in response to the sensor 50 being identified as the second classification in the identification step, the processor 10 receives an input value of the sensor 50, connected to the port 40, during a second period of time to calculate an average input value during the second period of time and sets a product obtained by multiplying the average input value by a predetermined multiple value according to the type of sensor 50 as a threshold value of the port 40.

Here, the first classification may be a classification for sensing infrared rays or carbon dioxide concentration. When the sensor system 1 is installed, a sensing target such as infrared rays or carbon dioxide concentration may have a different threshold set according to the installation environment. This is because the environment in which the sensor system 1 of the present disclosure is installed may be an environment in which infrared rays are detected frequently or highly even in a normal state or an environment in which a high concentration of carbon dioxide is sensed. If the sensor system 1 is installed in an environment such as a factory where a lot of carbon dioxide is generated, it is necessary to set a different threshold from an environment where carbon dioxide is not generated. To this end, the processor 10 receives an input value of the sensor 50, connected to the port 40, through the port 40 during the second period of time to calculate an average input value. The average input value calculated by the processor 10 is used as the standard for an input value received by the sensor 50 in an environment in which the sensor system 1 is installed.

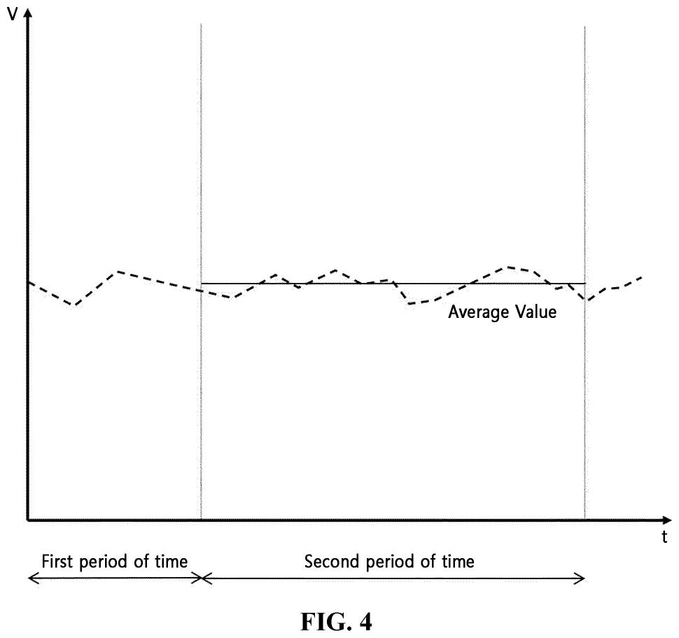

As shown in FIG. 4, the second period of time may be set longer than the first period of time. While the first period of time is a period of time for the processor 10 to determine only which section the input value belongs to, the second period of time is a period of time for the processor 10 to calculate the average input value and thus longer than the first period of time. That is, when the sensor 50 is coupled to the port 40, it is possible to determine within a short time whether the sensor 50 is of the first classification or the second classification, but a sufficient period of time is required to calculate the average input value according to an environment in which the sensor system 1 is installed.

For a sensor of the second classification, a threshold value of a port may be generated based on an average input value. Specifically, the threshold value may be generated according to a predetermined threshold value calculating method using the average input value as an input variable. For example, the threshold value calculating method may be a method of multiplying an average input value by a predetermined multiple value.

As described above, after the average input value is calculated, the threshold value of the corresponding port 40 may be set by multiplying the average input value by a predetermined multiple value according to a type of the sensor 50. At this point, the memory 20 may store the multiple value for the type of the second classification in advance, and the processor 10 may load the corresponding multiple value from the memory 20 and multiply the average input value by the multiple value to set a threshold value of the corresponding port 40.

In the second classification threshold setting step, a range of input values may be set for each type of the sensor 50 and the type of sensor 50 may be identified according to an input value received during the first period of time. For example, if the input value received by the sensor 50 is in the range of 0V to 5V, the range of 0V to 0.8V may be set as section A, the range of 0.8V to 1.6V may be set as section B, the range of 1.6V to 2.4V may be set as section C, and the range of 2.4V-3.2V may be set as D section.

For example, as shown in FIGS. 3 and 4, when an input value corresponding to section B is received during the first period of time, the processor 10 may identify that the sensor 50 is of the second classification and corresponds to type B. Thereafter, the processor 10 may load a multiple value corresponding to type B from the memory 20.

The multiple value for the second classification, which is stored in the memory 20, may be changed by a user through the control terminal 70. Since the user needs to change the multiplier value of the second classification as needed, the multiplier value of the second classification stored in the memory 20 may be changed through the communication part 30 connected to the control terminal 70.

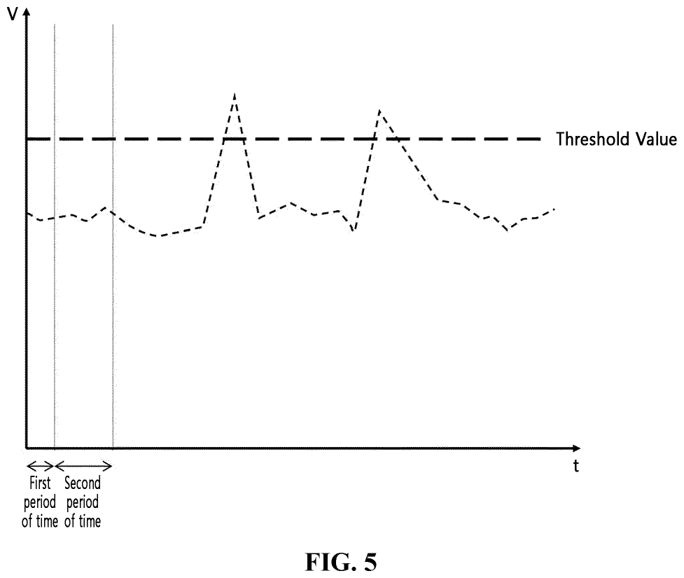

As shown in FIG. 5, after a threshold value for each sensor 50 is set, an anomaly monitoring step starts. That is, after a lapse of the first period of time and the second period of time, the sensor system 1 may normally sense a sensing target of the external environment. When receiving an input value exceeding the aforementioned threshold value, the processor 10 may determine that the external environment is dangerous. FIG. 5 shows a case where the processor 10 receives an input value exceeding a threshold value twice. As such, when an input value exceeding the threshold value is received, the processor 10 may transmit a danger signal corresponding thereto to the control terminal 70.

The processor 10 may determine a largest value among input values received for a predetermined period, for example, 1 second, as a representative value. The processor may count an input value exceeding a threshold value for a predetermined period of time, for example, 1 second. The processor 10 may determine a degree of risk in the external environment based on the number of times the representative value or threshold value is exceeded.

The sensor system 1 according to the present disclosure may be a fire detection system. The above-described sensor 50 senses temperature, humidity, infrared rays, carbon dioxide concentration, etc. to detect fire so that the processor 10 can determine a risk of fire. The risk of fire determined by the processor 10 may be transmitted to the control terminal 70 and delivered to the user.

The technical features disclosed in each embodiment of the present disclosure are not limited to a corresponding embodiment, and unless incompatible with each other, the technical features disclosed in each embodiment may be applied in combination to other embodiments.<

In the above, the embodiments of the method for setting the threshold value of the sensor according to the present disclosure have been described. The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.
1: sensor system
10: processor
20: memory
30: communication part
40: port
50: sensor
60: base part
70: control terminal

1. A method for setting a threshold value of a sensor in a sensor system having at least one processor and at least one port for transmitting a signal to the at least one processor, the method comprising:
an initial reception step in which the at least one processor receives an input value of a sensor, connected to the at least one port, through the at least one port during a first period of time;
an identification step in which the at least one processor identifies a type of the sensor based on to which section the input value received in the initial reception step corresponds among a plurality of predetermined sections;
a first classification threshold setting step in which, in response to the sensor being identified as a first classification in the identification step, the at least one processor sets a predetermined threshold value according to the type of the sensor as a threshold value of the at least one port; and
a second classification threshold value setting step in which, in response to the sensor being identified as a second classification in the identification step, the at least one processor receives an input value of the sensor, connected to the at least one port, through the at least one port during a second period of time to calculate an average input value during the second period of time, and sets a threshold value of the at least one port based on the average input value.

2. The method of claim 1, wherein the initial reception step further comprises removing noise from the input value of the sensor.

3. The method of claim 1, wherein the second period of time is longer than the first period of time.

4. The method of claim 1,
wherein the first classification is a classification for sensing temperature or humidity, and
wherein the second classification is a classification for sensing infrared rays or carbon dioxide concentration.

5. The method of claim 4, wherein the sensor system is a fire detection system.

6. The method of claim 1,
wherein the sensor system further comprises a memory,
wherein the memory stores the threshold value according to a type of the sensor of the first classification, and
wherein the first classification threshold value comprises loading the threshold from the memory by the at least one processor.

7. The method of claim 1,
wherein the sensor system further comprises a memory,
wherein the memory stores the multiple value according to a type of the sensor of the second classification, and
wherein the second classification threshold setting step comprises loading the multiple value from the memory by the at least one processor.

8. The method of claim 1, wherein the first classification threshold value setting step further comprises setting a range of input values for each type of the sensor and identifying a type of the sensor according to an input value received during the first period of time.

9. The method of claim 1, wherein the second classification threshold value setting step further comprises setting a range of input values for each type of the sensor and identifying the type of the sensor according to an input value received during the first period of time.

10. The method of claim 1, wherein in the second classification threshold setting step, the at least one processor sets, as the threshold value of the at least one port, a product obtained by multiplying the average input value by a predetermined multiple value according to the type of the sensor.

11. A sensor system comprising:
a memory;
at least one processor configured to execute instructions stored in the memory; and
at least one port configured to transmit a signal to the at least one processor,
wherein the processor is further configured to:
receive an input value of a sensor, connected to the at least one port, through the at least one port during a first period of time, and
identify a classification for the sensor based on to which section the input value received in the initial reception step corresponds from among a plurality of predetermined sections,
wherein in response to the sensor being identified as a first classification in the identification step, the at least one processor sets a predetermined threshold value according to the type of the sensor as a threshold value of the at least one port, and
wherein in response to the sensor being identified as the second classification in the identifying step, the at least one processor receives an input value of a sensor, connected to the at least one port, through the at least one port during a second period of time, and calculates an average input value during the second period of time.
